(19) United States
(12) Patent Application Publication
(10) Pub. No.: US 2007/0085822 A1
(43) Pub. Date: Apr. 19, 2007

(54) Wireless transmitter enabling/disabling system

(76) Inventor: Isaac Lagnado, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/249,594

(22) Filed: Oct. 13, 2005

(51) Int. Cl. G09G 5/00

(52) U.S. Cl. 345/156

(57) ABSTRACT

A computer device comprises a display member coupled to a base member to enable variable positioning of the display member relative to the base member. The computer device also comprises an enabling/disabling system configured to automatically disable a wireless transmitter without changing an operating state of the computer device based on a position of the display member relative to the base member.

### BACKGROUND OF THE INVENTION

Computer devices, such as laptop or notebook computers, utilize wireless radio transmitters to facilitate wireless communications with one or more external sources. However, under particular circumstances, a user may desire to turn the transmitter off (e.g., for power consumption reasons (e.g., save battery life), plane travel or otherwise). One method for facilitating turning the wireless transmitter off is a manually actuatable switch. However, computer devices that incorporate such manual switches are inconvenient for the user and are inadequate if the user forgets to manually actuate the switch.

### BRIEF DESCRIPTION OF THE DRAWINGS

For a more complete understanding of the present invention, and the objects and advantages thereof, reference is now made to the following descriptions taken in connection with the accompanying drawings in which:

FIG. 1 is a front perspective view of a computer device employing an embodiment of a wireless transmitter enabling/disabling system to advantage in accordance with the present invention;

FIG. 2 is a front perspective view of a computer device employing another embodiment of a wireless transmitter enabling/disabling system to advantage in accordance with the present invention; and

FIG. 3 is a flow diagram illustrating an embodiment of a wireless transmitter enabling/disabling method in accordance with the present invention.

### DETAILED DESCRIPTION OF THE DRAWINGS

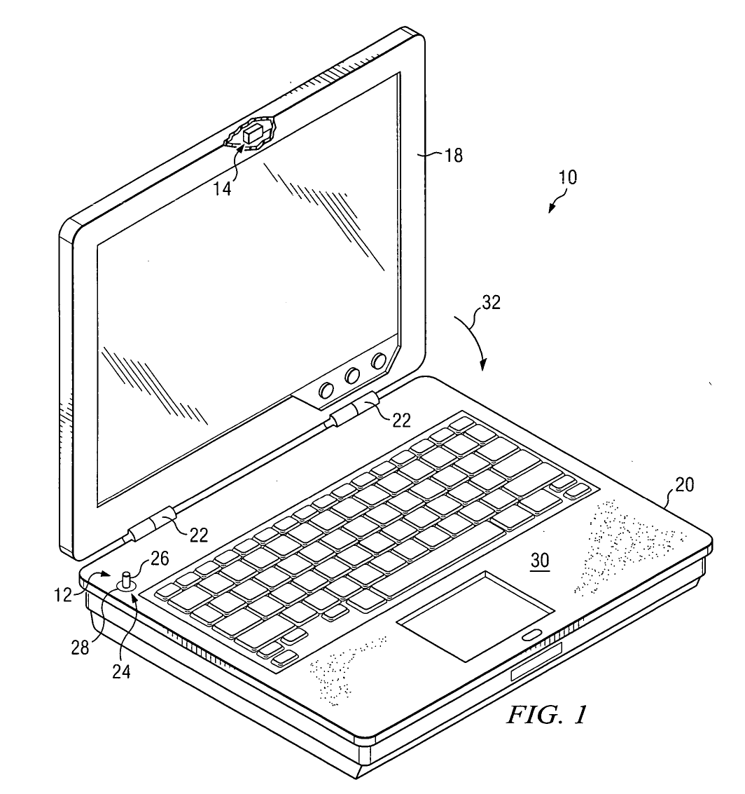

The preferred embodiments of the present invention and the advantages thereof are best understood by referring to FIGS. 1-3 of the drawings, like numerals being used for like and corresponding parts of the various drawings.

FIG. 1 is a front perspective view of a computer device 10 employing an embodiment of an enabling/disabling system 12 for a wireless transmitter 14. In the embodiment illustrated in FIG. 1, computer device 10 comprises a laptop or notebook computer. However, it should be understood that computer device 10 may comprise other types of computer devices such as, but not limited to, tablet personal computers and other types of portable and/or handheld computing devices. In the embodiment illustrated in FIG. 1, computer device 10 comprises a display member 18 rotatably coupled to a base member 20 by hinges 22. In the embodiment illustrated in FIG. 1, wireless transmitter 14 is disposed within display member 18. However, it should be understood that wireless transmitter 14 may be otherwise located. Wireless transmitter 14 may comprise, for example, a radio frequency (RF) antenna, a planar inverted f-antenna (PIFA), a loop type antenna and/or other type of antenna mechanism coupled to related internal circuitry of computer device 10. In FIG. 1, only a single wireless transmitter 14 is illustrated as being disposed in display member 18. However, it should be understood that a greater number of wireless transmitters 14 can be disposed within display member 18 and/or within base member 20.

In the embodiment illustrated in FIG. 1, system 12 comprises a switch 24 for detecting a position of display member 10 relative to base member 20. In the embodiment illustrated in FIG. 1, switch 24 comprises a depressable button 26 biased to extend at least partially upward through an opening 28 on a working surface 30 of base member 20 and retract at least partially into base member 20 in response to contact therewith by display member 18 (e.g., contact resulting from display member 18 being moved from an open position as illustrated in FIG. 1 toward and/or into a closed position relative to base member 20). However, it should be understood that button 26 may be otherwise located (e.g., elsewhere on working surface 30, a reversed position where button 26 is located on display member 18, etc.). Further, it should be understood that other devices and/or mechanisms may be used instead of button 26 (e.g., a contact element, mechanical toggle, etc.).

In operation, as display member 18 is rotated in the direction indicated by arrow 32 toward base member 20 to a closed and/or predetermined position or arrangement relative to base member, display member 18 approaches base member 20 and engages button 26, thereby actuating switch 24. Actuation of switch 24 causes an interrupt and/or other type of signal to be generated and/or otherwise processed via hardware, software and/or a combination thereof of computer device 10 (e.g., via a basic input/output system (BIOS), operating system or other hardware and/or software-based component of computer device 10) to disable wireless transmitter 14 while one or more other operational systems and/or components of computer device 10 remain in an “on” or powered state and/or condition (e.g., the remaining one or more other operational systems and/or components of computer device 10 are unaffected by disabling of transmitter 14). Thus, in operation, once the computer device 10 is closed (e.g., display member 18 brought within a predetermined arrangement, distance and/or position relative to base member 20), transmitter 14 is disabled.

Embodiments of the present invention also provide automatic enablement of transmitter 14. For example, in the embodiment illustrated in FIG. 1, in response to movement of display member 18 away from base member 20 and/or from a predetermined position or arrangement relative to base member 20, display member 18 disengages button 26, thereby causing a signal to be generated and/or otherwise processed via hardware, software and/or a combination thereof of computer device 10 (e.g., via a basic input/output system (BIOS), operating system or other hardware and/or software-based component of computer device 10) to enable wireless transmitter 14 while one or more other operational systems and/or components of computer device 10 remain unaffected.

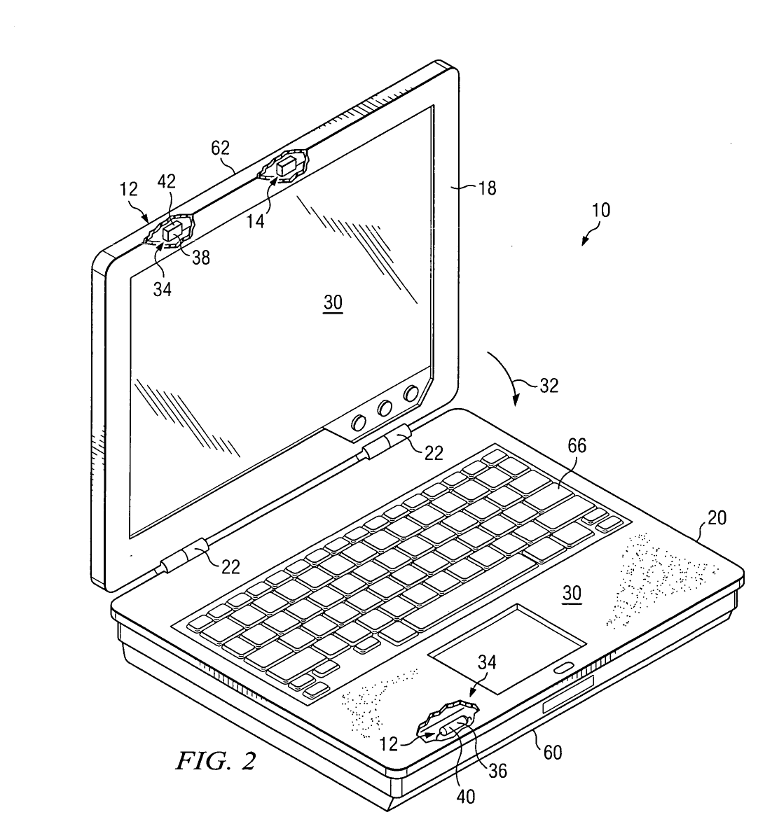

FIG. 2 is a front perspective view of computer device 10 employing another embodiment of enabling/disabling system 12 to advantage. In the embodiment illustrated in FIG. 2, system 12 comprises a switch 34 comprising a sensor element 36 disposed in base member 20 and a sensor element 38 disposed in display member 18. In operation, switch 34 interrupts and/or transmits a signal generated and/or otherwise processed via hardware, software and/or a combination thereof of computer device 10 to disable wireless transmitter 14 in response to sensor elements 36 and 38 being positioned within a predetermined distance and/or in close proximity to each other. Accordingly, when display member 18 is in the closed and/or in another predetermined arrangement or position relative to base member 20, wireless transmitter 14 is disabled while one or more other systems and/or components of computer device 10 remain in an “on” or powered state. In the embodiment illustrated in FIG. 2, sensor element 36 comprises a reed switch 40 and sensor element 38 comprises a magnet 42 such that reed switch 40 is actuated in response to a magnetic field generated by magnet 42. Accordingly, actuation of reed switch 40 causes the interrupt and/or the generated signal to disable wireless transmitter 14. It should also be understood that the location and/or position of reed switch 40 and magnet 42 may be otherwise reversed (e.g., reed switch 40 located in display member 18 and magnet 42 located in base member 20). Additionally, it should be understood that other types of non-mechanical sensor elements may be used in switch 34 for detecting the positioning of display member 18 relative to base member 20

Embodiments of the present invention also provide automatic enablement of transmitter 14. For example, in the embodiment illustrated in FIG. 2, in response to movement of display member 18 away from base member 20 and/or from a predetermined position or arrangement relative to base member 20, switch 34 is de-actuated (e.g., in response to sensor elements 36 and 38 moving away from each other), thereby causing a signal to be generated and/or otherwise processed via hardware, software and/or a combination thereof of computer device 10 (e.g., via a basic input/output system (BIOS), operating system or other hardware and/or software-based component of computer device 10) to enable wireless transmitter 14 while one or more other operational systems and/or components of computer device 10 remain unaffected.

Sensor elements 36 and 38 are positionable in a variety of locations on display member 18 and/or base member 20 to accommodate a variety of arrangements of display member 18 relative to base member for automatically enabling and/or disabling transmitter 14. For example, in some embodiments of the present invention, sensors 36 and 38 are positioned to enable automatic enablement/disablement of transmitter 14 when display member 18 is used in a tablet mode. For example, in some embodiments of the present invention, sensor element 36 is positioned in close proximity and/or near a bottom surface 60 of base member 20 and sensor element 38 is positioned in close proximity and/or near a rear surface 62 of display member 18. In such an embodiment, in response to display member 18 being rotated relative to base member 20 in a direction opposite the direction 32 (e.g., rotating display member 18 away from a keyboard 66) to wrap or otherwise cause display member 18 to be positioned near or against bottom surface 60 of base member 20, thereby positioning display member 18 in a tablet mode, sensors elements 36 and 38 become positioned within a predetermined distance and/or in close proximity to each other, thereby causing disablement of transmitter 14. Correspondingly, in response to movement of display member 18 out of tablet mode (e.g., moving display member 18 away from bottom surface 60 of base member 20), movement of display member 18 away from a predetermined position and/or arrangement relative to base member 20 causes automatic enablement of transmitter 14.

In yet other embodiments of the present invention, sensor elements 36 and 38 are positionable at multiple locations on display member 18 and/or base member 20 to automatically enable and/or disable transmitter 14 in response to display member 18 being positioned at different positions and/or arrangements relative to base member 20. For example, in some embodiments of the present invention, computer device 10 is configured to enable use of display member 18 in a tablet mode while positioned near or against bottom surface 60 (e.g., rotation of display member in a direction opposite direction 32 as described above) or in a tablet mode while positioned near or against keyboard 66 (e.g., rotation of display member about a vertical axis to reverse a direction of a display element of display member 18 to face away from keyboard 66). Thus, in some embodiments of the present invention, sensor elements 36 and 38 are positioned at one or more locations on base member 20 and one or more locations on display member 18 to automatically disable transmitter 14 when display member 18 is used in a tablet mode in any of a variety of arrangements relative to base member 20. Correspondingly, in response to movement of display member away from a predetermined tablet arrangement relative to base member 20, transmitter 14 is automatically enabled.

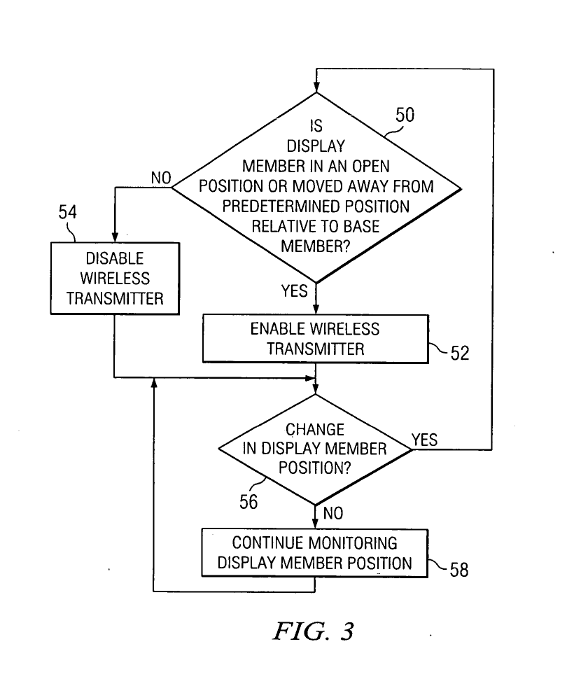

FIG. 3 is a flow diagram illustrating an embodiment of a transmitter 14 enabling/disabling method in accordance with the present invention. The method begins at decisional block 50, where a determination is made as to a position and/or arrangement of display member 18 relative to base member 20. If it is determined that display member 18 is in an open position relative to base member 20 or has been moved away from a closed or other predetermined position or arrangement relative to base member 20, the method proceeds to block 52, where transmitter 14 is activated and/or otherwise operationally enabled. If it is determined at block 50 that display member 18 is in a closed or other predetermined position or arrangement relative to base member 20 (e.g., by actuation of switch 24 or 34), the method proceeds to block 54 where transmitter 14 is disabled. At decisional block 56, a determination is made whether a change to a position and/or arrangement of display member 18 relative to base member 20 has occurred. If a change to the position of display member 18 relative to base member 20 has not occurred, the method proceeds to block 58, where the position of display member 18 relative to base member 20 continues to be monitored. If a change to the position or arrangement of display member 18 relative to base member 20 has occurred, the method returns to block 50.

Embodiments of the present invention provide a computer device 10 to enable wireless transmitter 14 to be automatically activated and/or disabled based solely on the position of display member 18 without affecting an operating state and/or powered condition of computer device 10 as a whole and/or other operational components of computer device 10. Thus, embodiments of the present invention enable activation and/or disabling of transmitter 14 independently of other operational components and/or systems of computer device 10, thereby enabling an operating system and other operation components and/or applications to remain unaffected by such transmitter 14 activation/disablement. Further, embodiments of the present invention conserve power (e.g., providing for automatic transmitter 14 disablement in response to closing of display member 18 relative to base member 20), alleviate concern that a wireless transmitter 14 is emitting signals that may be considered harmful under particular circumstances, and avoid confusion and/or interference between computer device 10 and other wired and wireless networks (e.g., transmitter 14 automatically disabled when stowed on an airplane in a closed position). In addition, embodiments of the present invention enable disabling system 12 to automatically disable wireless transmitter 14 without powering down computer device 10 and/or the operating system so as to avoid rebooting computer device 10 when it is desired to reactivate wireless transmitter 14.

What is claimed is:

1. A computer device comprising:
a display member coupled to a base member to enable variable positioning of the display member relative to the base member; and
an enabling/disabling system configured to automatically disable a wireless transmitter without changing an operating state of the computer device based on a position of the display member relative to the base member.

2. The computer device of claim 1, wherein the enabling/disabling system further comprises a switch adapted to transmit a signal indicative of the position of the display member relative to the base member.

3. The computer device of claim 1, wherein the enabling/disabling system comprises a switch actuatable in response to the display member being proximally positioned relative to the base member.

4. The computer device of claim 1, wherein the enabling/disabling system comprises a switch actuatable in response to the display member being moved toward a closed position relative to the base member.

5. The computer device of claim 1, wherein the enabling/disabling system comprises a magnet and a reed switch responsive to the magnet.

6. The computer device of claim 1, wherein the enabling/disabling system is configured to disable the wireless transmitter in response to the display member being positioned in close proximity to the base member.

7. The computer device of claim 1, wherein the enabling/disabling system comprises a switch adapted to transmit a signal to disable the wireless transmitter in response to the display member being positioned in close proximity to the base member.

8. The computer device of claim 1, wherein the enabling/disabling system is configured to automatically enable the wireless transmitter in response to the display member being moved away from a predetermined position relative to the base member.

9. The computer device of claim 1, wherein the enabling/disabling system is configured to automatically disable the wireless transmitter in response to the display member being positioned in a predetermined tablet mode arrangement relative to the base member.

10. A computer device, comprising:
a display means coupled to a base means to enable variable positioning of the display means relative to the base means; and
means for automatically disabling a wireless transmission means without changing an operating state of the computer device based on a position of the display means relative to the base means.

11. The computer device of claim 10, wherein the disabling means comprises a switch means adapted to transmit a signal indicative of the position of the display means relative to the base means.

12. The computer device of claim 10, wherein the disabling means comprises a switch means actuatable in response to the display means being disposed in close proximity to the base means.

13. The computer device of claim 10, wherein the disabling means comprises a means to engage the display means in response to the display means being moved toward a closed position relative to the base means.

14. The computer device of claim 10, further comprising means for automatically enabling the wireless transmission means in response to the display means being moved away from a predetermined position relative to the base means.

15. The computer device of claim 10, wherein the disabling means comprises a switch means adapted to transmit a signal to disable the wireless transmission means in response to the display means being in a closed position relative to the base means.

16. A method of manufacturing a computer device, comprising:
coupling a display member to a base member to enable variable positioning of the display member relative to the base member; and
providing an enabling/disabling system configured to automatically disable a wireless transmitter without changing an operating state of the computer device based on a position of the display member relative to the base member.

17. The method of claim 16, wherein providing the enabling/disabling system comprises providing a switch configured to transmit a signal indicative of the position of the display member relative to the base member.

18. The method of claim 16, wherein providing the enabling/disabling system comprises providing a switch actuatable in response to the display member being disposed in close proximity to the base member.

19. The method of claim 16, wherein providing the enabling/disabling system comprises providing a switch adapted to engage the display member in response to the display member being moved toward a closed position relative to the base member.

20. The method of claim 16, wherein providing enabling/disabling system comprises providing a magnet and providing a reed switch responsive to the magnet.

21. The method of claim 16, further comprising configuring the enabling/disabling system to automatically enable the wireless transmitter in response to the display member being moved away from a predetermined position relative to the base member.

22. The method of claim 16, further comprising configuring the enabling/disabling system to automatically disable the wireless transmitter in response to the display member being positioned in a predetermined tablet mode arrangement relative to the base member.

23. A computer device comprising:
a display member coupled to a base member to enable variable positioning of the display member relative to the base member; and
an enabling/disabling system configured to automatically enable a wireless transmitter without changing an operating state of the computer device based on a position of the display member relative to the base member.

24. The computer device of claim 23, wherein the enabling/disabling system further comprises a switch adapted to transmit a signal indicative of the position of the display member relative to the base member.

25. The computer device of claim 23, wherein the enabling/disabling system comprises a switch actuatable in response to the display member being moved away from a closed position relative to the base member.

26. The computer device of claim 23, wherein the enabling/disabling system comprises a magnet and a reed switch responsive to the magnet.

27. The computer device of claim 23, wherein the enabling/disabling system is configured to automatically enable the wireless transmitter in response to the display member being moved away from a predetermined tablet mode arrangement relative to the base member.

28. A computer device comprising:
a display member coupled to a base member to enable variable positioning of the display member relative to the base member; and
an enabling/disabling system configured to automatically disable a wireless transmitter of the computer device without affecting other operational components of the computer device based on a position of the display member relative to the base member.

29. The computer device of claim 28, wherein the enabling/disabling system further comprises a switch adapted to transmit a signal indicative of the position of the display member relative to the base member.

30. The computer device of claim 28, wherein the enabling/disabling system comprises a switch actuatable in response to the display member being proximally positioned relative to the base member.

31. The computer device of claim 28, wherein the enabling/disabling system comprises a switch actuatable in response to the display member being moved toward a closed position relative to the base member.

32. The computer device of claim 28, wherein the enabling/disabling system comprises a magnet and a reed switch responsive to the magnet.

33. The computer device of claim 28, wherein the enabling/disabling system is configured to disable the wireless transmitter in response to the display member being positioned in close proximity to the base member.

34. The computer device of claim 28, wherein the enabling/disabling system comprises a switch adapted to transmit a signal to disable the wireless transmitter in response to the display member being positioned in close proximity to the base member.

35. The computer device of claim 28, wherein the enabling/disabling system is configured to automatically enable the wireless transmitter in response to the display member being moved away from a predetermined position relative to the base member.

36. The computer device of claim 28, wherein the enabling/disabling system is configured to automatically disable the wireless transmitter in response to the display member being positioned in a predetermined tablet mode arrangement relative to the base member
